(19) United States
(12) Patent Application Publication
(10) Pub. No.: US 2007/0067223 A1
(43) Pub. Date: Mar. 22, 2007

(54) ELECTRONIC METHOD AND SYSTEM FOR EXECUTING RETROACTIVE PRICE ADJUSTMENT

(75) Inventor: Jay Shields, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/162,675

(22) Filed: Sep. 19, 2005

(51) Int. Cl. G06Q 30/00

(52) U.S. Cl. 705/26

(57) ABSTRACT

An electronic method and system for executing retroactive price adjustments includes a computer that is configured to receive a purchase agreement pertaining to goods and/or services. The method includes receiving a price adjustment on a pricing line of the purchase agreement through the use of the computer and receiving an effective start date in which the price adjustment will take effect. The method also includes identifying release orders associated with the purchase agreement that are affected by the retroactive price adjustment via the computer. Additionally, the method includes updating the release orders and the purchase agreement to reflect the price adjustment.

### TECHNICAL FIELD

One aspect of the present invention relates generally to a system and method for retroactive price adjustments on purchase orders issued against purchase agreements for acquiring products and/or services from a supplier.

### BACKGROUND

Electronic procurement systems such as the Oracle 11i system, available from Oracle Corporation, 500 Oracle Parkway, Redwood Shores, Calif. 94065, enable organizations to purchase goods and/or services, coordinate the delivery of the goods and/or services, and monitor the status of such transactions. These procurement systems have streamlined the procurement process by providing a centralized location where buyers and suppliers can manage past, present and future transactions. Although these systems have experienced increased use and enhanced utility, there still remains a wide horizon for improvement.

For example, with the conventional systems, retroactive price adjustment is a critical function that these systems lack. Retroactive pricing generally refers to a situation where a price change is performed on a purchase order with an effective date in the past. Payments in these cases are adjusted to account for differences between an original price(s) for goods and/or services and a new price. With the conventional procurement systems, in the event of a retroactive price adjustment scenario, a receiver of goods or services, who has received those goods or services, is required to return the received amount so that the buyer can adjust the prices accordingly on any related purchase orders. Once the prices are adjusted by the buyer, the receiver must then re-receive the amount of goods or services previously returned. It is recognized that this process is cumbersome, time consuming, and subject to human error. Additionally, in many cases where retroactive pricing is necessary, the goods and/or services paid-for have not been fully received. In such a case, price adjustments are required for both the goods and/or services received as well as those not yet received. The conventional procurement systems are inept at efficient and cost-effective handling of such retroactive pricing events.

In light of the foregoing, the present invention was conceived in view of these and other disadvantages of the conventional procurement systems.

### SUMMARY OF THE INVENTION

The present invention provides a electronic method and system for executing retroactive price adjustments. The present invention includes an electronic method for executing the retroactive price adjustments involving a computer. The computer is configured to receive a purchase agreement pertaining to goods and/or services. The method includes receiving a price adjustment on a pricing line of the purchase agreement through the use of the computer in receiving an effective start date which the price adjustment will take effect. The method also includes identifying release orders associated with the purchase agreement that are affected by the retroactive price adjustment via the computer. Additionally, the method includes updating the release orders and the purchase agreement to reflect the price adjustment.

The above embodiments and other embodiments, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings in which:

FIG. 1 depicts a schematic diagram illustrating a system embodiment for implementing certain embodiments of the present invention;

FIG. 2 illustrates a flow chart for a retroactive pricing adjustment method in accordance with an embodiment of the present invention;

FIG. 3 illustrates a flow chart for initiating a retroactive pricing event in accordance with an embodiment of the present invention;

FIG. 4 illustrates a flow chart for retrieving documents and related information affected by the retroactive pricing event in accordance with an embodiment of the present invention;

FIG. 5 illustrates a flow chart for performing retroactive price adjustment and updating the affected documents and related information in accordance with an embodiment of the present invention;

FIGS. 6A-6C illustrate various examples of a blanket purchase agreement forms in accordance with an embodiment of the present invention;

FIG. 7 illustrates an example of a release order form in accordance with an embodiment of the present invention;

FIG. 8 illustrates an example of a receipt history form in accordance with an embodiment of the present invention; and

FIG. 9 illustrates an invoice form in accordance with an embodiment of the present invention.

These figures are intended for exemplary purposes of illustrating different capabilities of the method and system disclosed herewith having capabilities for retroactive pricing for use in order procurement.

### DETAILED DESCRIPTION OF THE EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ in the present invention.

A system having capabilities for retroactive pricing for use in order procurement can include any number of computer related microprocessing and software applications. The microprocessing and software applications are referenced to as tools. The system can include various tools for achieving retroactive capabilities, and the system can include tools associated with a purchase agreement, a release order, a receipt, an invoice, and some type of microprocessing device having software applications capable of performing retroactive actions.

A retroactive pricing tool is provided so retroactive pricing amendments can be entered into purchase ordering systems. The tool allows buyers to initiate changes to release (or purchase) orders and purchase agreements with a price that is retroactive, meaning all products acquired after the price change receive the new price and a debit/credit is issued for products previously acquired to which the price change pertains. Accordingly, payments made at an original price for goods or services already received can be adjusted based on a difference between the original price and the new price.

The retroactive pricing tool can allow a buyer the capability to electronically amend an existing standard purchase order or blanket purchase agreement with a new price effective for a date in the past. The buyer could enter an effective start date for the price change. Moreover, a price change can trigger a normal revision and re-approval process, whereby price changes can become firm when the approval process is complete.

Moreover, a history can be maintained to capture price changes with the corresponding effective start and end dates, where applicable, so that the buyers can have access to the data stored therein.

The retroactive pricing tool can enable a supplier to be paid or billed for an amount of a retroactive adjustment by issuing a debit or credit in accordance with the retroactive price adjustment.

The retroactive pricing tool can provide an invoice for calculating tax on a line-by-line basis for meeting the needs of different countries, like Brazil and Argentina.

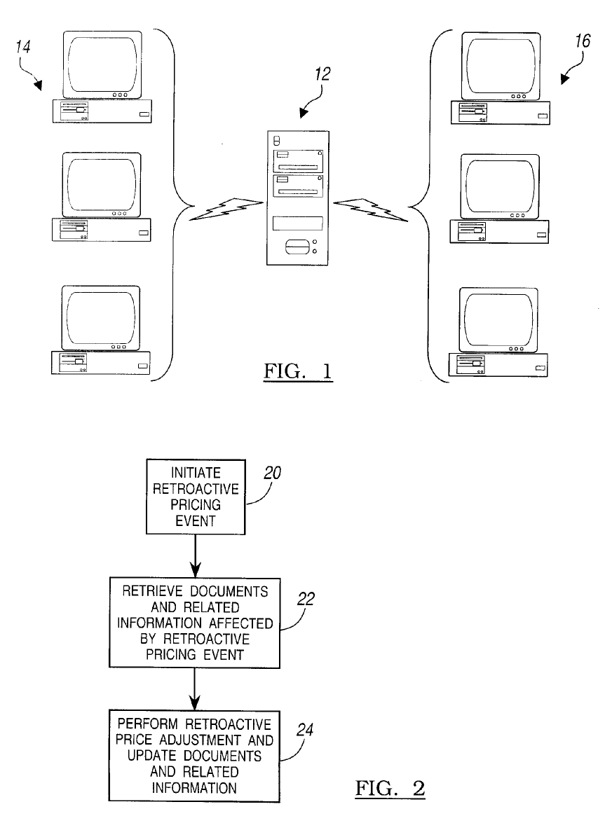

Now referring to FIG. 1, a schematic diagram illustrates a system embodiment for implementing certain embodiments of the present invention. FIG. 1 illustrates a server computer 12 operably serving a plurality of client computers 14 and 16, which may utilize a TCP-IP communication protocol via a network/LAN. Server computer 12 can be configured to operably store information to, and retrieve data from, at least one purchasing database integrated therein. It is recognized that the purchasing database may be located separate and apart from server computer 12 without departing from the scope of the present invention. Client computers 14 and 16 may be used by a buyer and a supplier to coordinate and manage the exchange of goods/services for payments. In one aspect, client computers 14 and 16 may be a single terminal or multiple terminals (as shown in FIG. 1), for use by the buyer and the supplier. In either embodiment, through the use of client computers 14 and 16, and server computer 12, the buyer and the supplier may access, modify and store purchase agreements, release orders, receipts, and invoices through the use of a retroactive pricing tool. The retroactive pricing tool can be implemented using Oracle Purchasing, Accounts Payable, and/or Sourcing applications.

Nevertheless, the purchase agreement represents an agreement between a purchaser and a seller for terms and conditions of a sale of a product from the buyer to the seller. For example, in the automotive industry, blanket purchase agreements are often made between a buyer and a supplier, whereby the buyer can continuously acquire products from the supplier in accordance with the terms of the purchase agreement on a regular basis, or even on an irregular basis when the buyer so desires.

When the buyer desires to acquire products from a supplier, a user creates a requisition against the purchase agreement for the specific product of interest. In response, the system generates a release order which provides further detail to the supplier regarding the specific product and quantities. As such, it is recognized that a single purchase agreement may have a plurality of requisitions and, hence, a plurality of associated release orders.

Accordingly, the retroactive pricing tool can include data relevant to the terms of the agreement, like a price, a start date, and an end date, which can be communicated to server computer 12 having a microprocessor for data storage and manipulation. This data can be entered by the buyer using a data entry tool, such as client computers 14 and 16, or by a computer automatically retrieving the information from other databases and legacy systems, or any other means. Ordinarily, once the release order is created and received by the supplier, the supplier ships the products to the buyer.

When the supplier ships the products to a buyer's plant, a receipt can be generated through the use of a receipt tool that is integrated with the retroactive pricing tool to signify physical receipt of the product by the plant. As is common in the automotive industry, the receipt can be caused to be generated by the buyer, the plant or automatically with logistics type software systems. The receipt tool can include data, like a receipt quantity, receipt history, receipt date, shipment date, and product item number which can be communicated to a computer for data storage and manipulation.

Based on the data from the receipt, the computer can cause the generation of an invoice by an invoice tool that is integrated with the retroactive pricing tool. The invoice tool includes data, like a detailed list of goods shipped or received and an invoice amount. The invoice amount represents the value for the product purchased under purchase order. The invoice is delivered to the supplier as a payment for a debit or credit against the supplier for the purchased products. The payment can be delivered by mail or by electronic funds transfer (EFT).

As evidenced by the foregoing, the system includes a number of tools which provide different capabilities for retroactive pricing for use in order procurement. These tools, and the others described below, allow the system to provide efficient and seamless retroactive pricing.

It is recognized that subsequent to the receipt of the products, pursuant to the release order and purchase agreement, the buyer and supplier may re-enter negotiations pertaining to the previously ordered products. The buyer and supplier may re-enter negotiations pertaining to the price of the products for various reasons, such as an increase in the price of raw materials required to produce the product or as a price concession to the buyer.

Accordingly, regardless of the reasons, when the buyer and supplier come to an agreement as to the price adjustment, the retroactive pricing tool is adapted to receive the new terms of the agreement (e.g., the price) and update associated release orders, receipts, and invoices. In one embodiment, the retroactive pricing tool allows a buyer to modify the purchase agreement by directly changing prices with respect to the product by adjusting the price and entering an effective date in which the new price is to become effective.

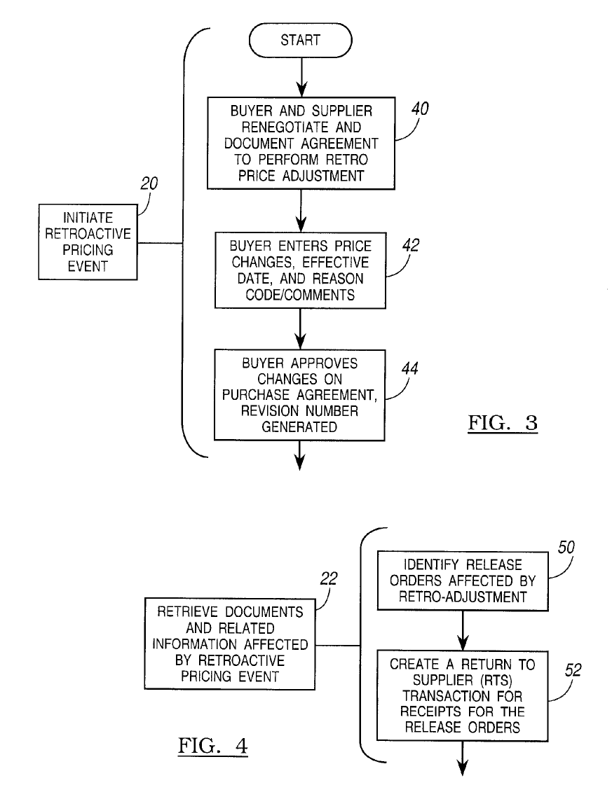

Now referring to FIG. 2, a flow diagram is illustrated that shows a method for retroactive price adjustment in accordance with an embodiment of the present invention. As shown by block 20, the method includes initiating a retroactive pricing event. As depicted by block 22, documents and related information affected by the retroactive pricing event are retrieved. Block 24 illustrates performing the retroactive price adjustment and updating the affected documents and related information in accordance with the retroactive pricing event.

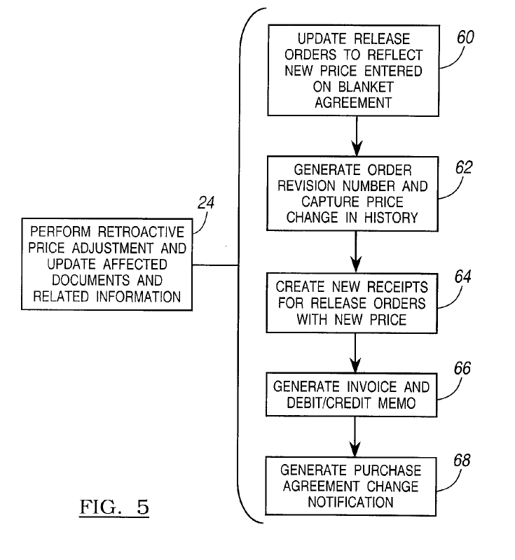

Referring to FIG. 3, a flow diagram is illustrated showing a method for initiating the retroactive pricing event. As depicted by block 40 and as described in the foregoing, the buyer and supplier renegotiate and document an agreement to perform a retroactive price adjustment to the purchase agreement. In one aspect, the buyer and supplier agree to a price change that occurs in the past after the buyer has received the parts or products under a particular purchase agreement. Alternatively, the buyer may have received only a percentage of the products or services pursuant to the purchase agreement and release order. In either embodiment, as depicted by block 42, the buyer enters the price changes, and a reason code or comment pertaining to the retroactive price adjustment, through the use of the retroactive pricing tool. It is recognized that the buyer may enter multiple price adjustments and effective start dates in accordance with the agreement to perform the retroactive price adjustment. The price is effective for life of agreement unless another price adjustment is applied. It is further recognized, that the buyer may enter a first price adjustment for a predetermined percentage of the goods or services received and enter a second or additional price adjustments for the remaining percentage of goods or services, pursuant to the purchase agreement. Accordingly, the retroactive pricing tool is configured to update the purchase agreement and related release orders to reflect the price adjustment for goods and services received and for goods or services not yet received as described hereinafter.

As shown in block 44, the buyer approves the changes to the purchase agreement and a revision number may be generated by the retroactive pricing tool. Approval of the price adjustment may occur through the use of the retroactive pricing tool. The revision number enables a user of the retroactive pricing tool to keep track of changes or revisions made in relation to the purchase agreement.

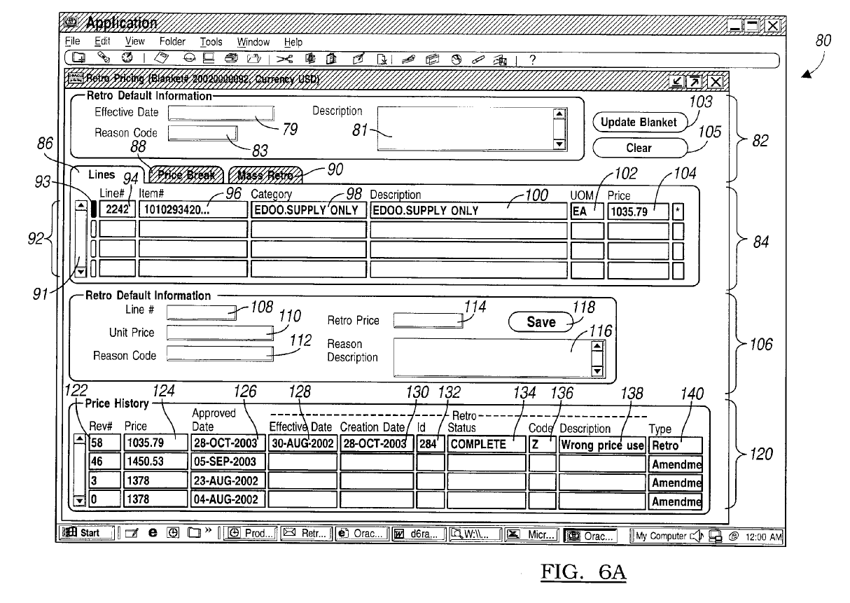

Now referring to FIG. 4, a flow diagram is illustrative of a method for retrieving documents and related information affected by the retroactive pricing event. As depicted by block 50, once the retroactive price event is initiated, the retroactive pricing tool is adapted to identify release orders affected by the retroactive pricing event. As shown in block 52, the retroactive pricing tool creates a return to supplier (RTS) transaction for receipts associated with the release orders. If no receipts have been created, then block 52 may be excluded.

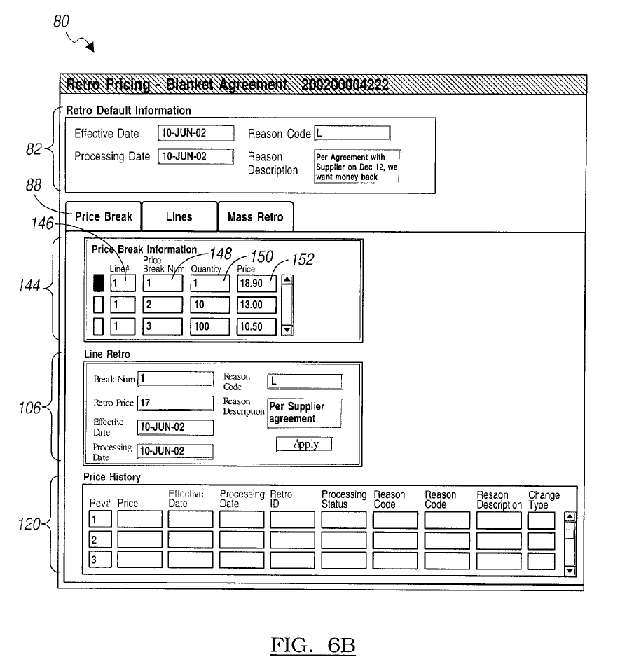

Now referring to FIG. 5, a flow diagram is illustrated showing a method for performing the retroactive price adjustments and updating the affected documents and related information. As shown in block 60, the retroactive pricing tool updates the release orders affected by the retroactive pricing event to reflect the new price that was previously entered on the blanket agreement. As depicted by block 62, the method generates an order revision number and may capture the price change history on the purchase agreement and/or the release order. As depicted by block 64, the retroactive pricing tool enables creation of new receipts for release orders affected by the new price. In the event no receipts have been generated based on the original blanket agreement (e.g., the buyer has not received the products pursuant to the blanket agreement), flock 64 may be excluded. In such a case, the system enables the price adjustment to be applied for future receipt and payment transactions. The retroactive pricing tool is further configured to capture a receipt history for prior receipts that were generated pursuant to a price adjustment to the purchase agreement. As depicted by block 66, the purchasing tool is configured to generate an invoice that reflects the retroactive price adjustment. Additionally, the retroactive pricing tool is configured to generate a debit or credit memorandum for the buyer and supplier. Accordingly, the retroactive pricing tool is configured to calculate any debits or credits as a result of the retroactive price adjustment. As such, as depicted by block 68, the retroactive pricing tool generates a purchase agreement change notification for notifying the supplier or alternatively, the buyer of the retroactive price adjustment.

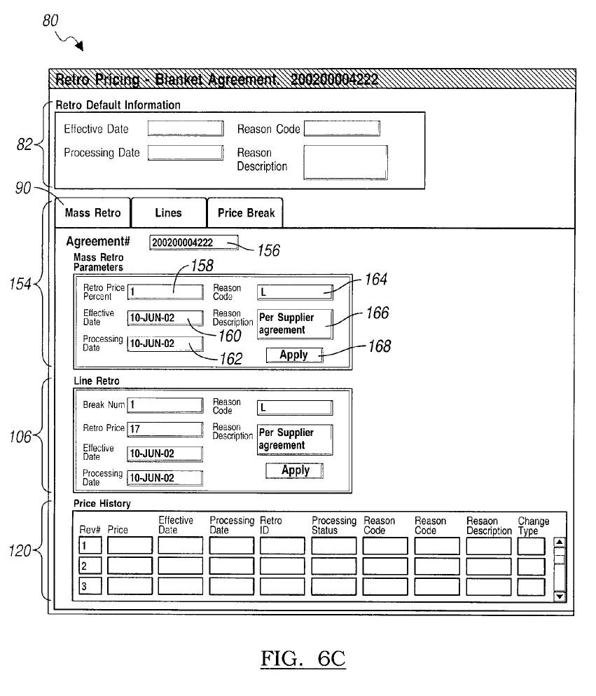

Now referring to FIG. 6A, an exemplary graphical user interface (GUI) illustrates a blanket purchase agreement in accordance with an embodiment of the present invention. Form 80 includes input fields 82 and tab sub-forms 84. Notably, input fields 58 can include, but are not limited to, an effective date field 79 which is the date upon which the retroactive pricing adjustment is to become effective. Input field 82 further includes a description field 81 in which the user may provide a narrative pertaining to the retroactive pricing event. A reason code 83 is shown for the user to input a code associated with the retroactive price adjustment. As shown, input fields 82 are included within a retroactive default information region.

Tab sub-forms 84 include a lines sub-form 86, a price break sub-form 88, and a mass retro sub-form 90. As illustrated in FIG. 6A, lines sub-form 86 includes multiple pricing lines 92. In one embodiment, price lines 92 are displayable through the use of the retroactive pricing tool but may not be revised or modified directly using pricing lines 92. A scroll 91 enables a user to scroll the list of pricing lines that have been retroactively adjusted via the retroactive pricing tool. Lines sub-form 86 includes an active line column 93, which when selected, notifies the buyer of the particular line in which the retroactive price adjustment will be performed. Accordingly, a line number field 94 displays a corresponding purchase order line number in which the retroactive price adjustment will occur. Item number field 96 displays the item number associated with the number shown in line number field 94. As such, a category field 98 displays a category code associated with the line number shown in line number field 94.

A description field 100 displays a description of the item number displayed in item number field 96. In the example shown in FIG. 6A, the retroactive pricing adjustment is to be performed on an item that is described as a “CARTRIDGE” followed by a code that further identifies the particular item affected by the retroactive price adjustment. A unit of measurement (UOM) field 102 displays a unit of measurement code associated with the line number displayed in line number field 94. A price field 104 displays the current line price, which, in one aspect does not reflect the price change as a result of the retroactive price adjustment. It is recognized that the particular fields illustrated are merely exemplary and are not intended to serve as a limitation to the present invention. Other embodiments of the present invention may include additional fields such as a quantity field that relates to the number of products associated with the item number displayed within item number field 96. Additionally, other embodiments may include fewer fields without departing from the scope of the present invention.

Form 80 further includes retroactive price fields 106 which are included within a line retro region of form 80. Retroactive price fields 106, in one aspect of the invention, may be configured to allow the user to directly input the parameters for selected purchase agreement line numbers pertaining to the retroactive price adjustment. Alternatively, certain specific fields within the line retro region may not be directly modified by the user in accordance with design requirements of the retroactive pricing tool. In another embodiment, a line number field 108 displays the particular line number in which the retroactive price adjustment is to be performed. In one embodiment, line number field 108 is a display only field as described above.

A unit price field 110 displays the current price of the product upon which the retroactive price adjustment will be performed. A reason code 112 is configured to allow the user to input a reason code associated with the retroactive price adjustment. A retro price field 114 allows the user to input the new retroactive price. A reason description field 116 enables the user to input a reason and/or description of the retroactive price adjustment. Once the retroactive price fields 106 are completed, the user may save the input information by clicking a save button 118. Form 80 further includes a price history region that has multiple price history fields 120. The price history region in one aspect of the invention is a display only region that displays prior price changes that are relevant to the purchase agreement. As will be described below, price history fields 120 may include both retroactive initiated price history as well as amendment initiated price history.

Additionally, a revision number field 122 displays a revision number of the purchase order in which the price adjustment was generated. A price field 124 displays a price associated with the revision number displayed in revision field number 122. An approval date field 126 displays the date in which a retroactive price adjustment was approved. An effective date field 128 displays the date in which the retroactive price adjustment became effective. A creation date field 130 displays the date in which the revision denoted by the revision number displayed in revision number field 122 was created. A retroactive identification (RID) 132 displays an identification number for the retroactive price adjustment. In one embodiment, each retroactive pricing event causes the generation of a RID. Accordingly, the user may query server computer 12 (FIG. 1) for a particular retroactive pricing event by searching for the corresponding RID. A retroactive status field 134 displays the status of the retroactive request. A code field 136 displays a retroactive code associated with the retroactive pricing adjustment. Additionally, a description field 138 displays a description pertaining to reasons for which the retroactive pricing event occurred.

A type field 140 displays the type of price adjustment that corresponds with the revision denoted by the revision number displayed in revision number field 122. Particularly, type field 140 may display whether the price adjustment is a result of an amendment initiated price change or a retroactive initiated price change.

Once the user has completed the retroactive price adjustment, the user may update the purchase agreement by selecting, through the use of client computers 14 and 16 (FIG. 1), on an update blanket button 103. Additionally, if the user desires to clear the entered information, the user may select a clear button 105.

Now referring to FIG. 6B, form 80 is shown having price break sub-form 88 displayed. Price break sub-form 88 includes a price break information region 144. price break information region 144 further includes a line number field 146, a price break number field 148, a quantity field 150, and a price field 152. Line number field 146 displays the particular purchase order line number upon which the retroactive price adjustment is to take place. The price break number 148 is a price break number associated with the purchase agreement line number. Quantity field 150 displays the price brake quantity for the particular price break line associated with the line number displayed in line number field 146. Additionally, price field 152 displays the price that corresponds with the price break quantity on the particular price break line that is associated with the line number displayed in line number field 146. FIG. 6B, as is shown in FIG. 6A, also includes input fields 82, retroactive price fields 106, and price history fields 120.

Now referring to FIG. 6C, form 80 is illustrated having mass retro sub-form 90 selected and displayed. Mass retro sub-form 90, which includes a mass retro region 154, enables a user to enter parameters for retroactively revising or modifying a purchase agreement. Accordingly, an agreement number field 156 displays the purchase agreement number that corresponds to the purchase agreement which is subject to the retroactive price adjustment. A retro price percent field 158 enables the user to enter percentages for the retroactive price adjustment. For example, the user may enter a positive or negative number that corresponds to the change in percentage of the current price. Accordingly, the values that may be entered in retro price percent field 158 may be restricted to a range of −100% to +100%. Additionally, mass retro region 154 includes an effective date field 160, a reason code field 164, a retroactive price adjustment processing date field 162, a reason code field 164, and a reason description field 166. Additionally, an apply button 168 enables the user to submit and apply the information entered into the mass retro sub-form 90.

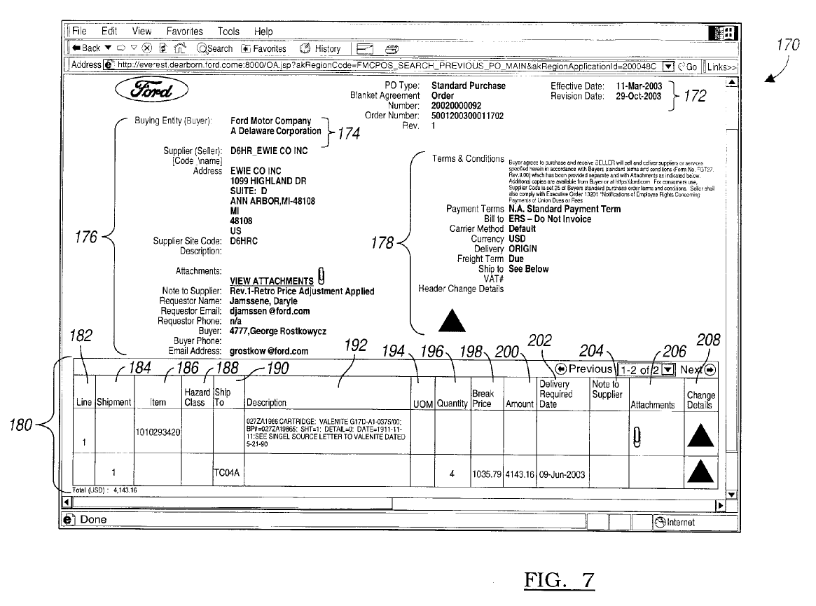

Referring now to FIG. 7, a release order form 170 is illustrated that corresponds to a purchase agreement in which the retroactive price adjustment has or will occur. As described in the foregoing, through the use of the retroactive pricing tool, the user may enter various price adjustment parameters that may be retroactively applied. Accordingly, the retroactive pricing tool is further configured to update other related documents that are affected by the retroactive price adjustment. Accordingly, form 170 illustrates a release order (also referred to as purchase order) that is associated with the purchase agreement. Form 170 includes a purchase order/release order general information region 172. Region 172 may include information pertaining to the purchase order type, the purchase agreement number, the release order number, the revision number, the effective date, and a revision date. A buyer information region 174 includes information pertaining to the name of the buyer. A supplier information region 176 includes information such as the supplier's name, address, a supplier site code, a description, attachments, a notes section, a requester name section, a requester e-mail, a requester phone field, a buyer's representative field, a buyer's phone number field, and a buyer's representative electronic mail address. A release order terms region 178 displays the terms and conditions of the particular release order affected by the retroactive pricing event and payment terms pertaining to the purchase agreement and release order. Region 178 also includes billing information and shipping information.

Additionally, form 170 includes a transaction data region 180. Transaction data region 180 includes a price line field 182, a shipment field 184, an item field 186, a hazard class field 188, and a shipping field 190. Region 180 further includes a description field 192, a unit of measurement field 194, a quantity field 196, a price break field 198, and an amount field 200. A delivery date field 202 is also included as well as a supplier note field 204 for entering notes regarding the supplier. Furthermore, an attachments field 206 and an information change field 208 are included within transaction data region 180. It is recognized that the embodiment illustrated by FIG. 7 is merely exemplary and the information contained therein may be modified or adapted without departing from the scope of the present invention.

As described in the foregoing, the retroactive pricing tool is configured to retrieve and update receipts that are affected by the retroactive price adjustment event. Accordingly, the retroactive pricing tool is adapted to capture the history of receipts that have been generated with respect to a purchase agreement. Accordingly, the software application can be used to search for receipts that fall within an effective date range for the particular item. Once the relevant receipts are determined, a variance calculation may occur and can be based on the new price and the last price paid.

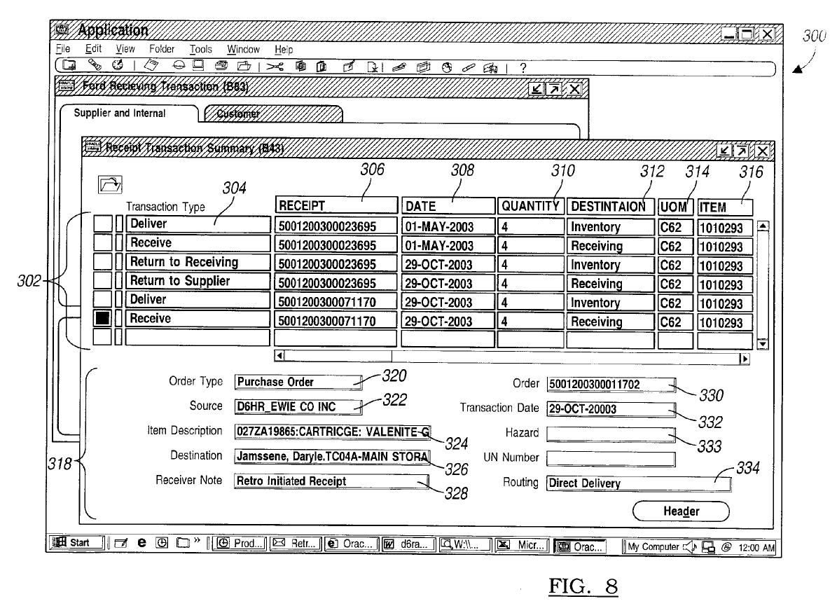

Accordingly, FIG. 8 is an example of an electronic receipt history that is generated as a result of a retroactive pricing event. Form 300 includes multiple receipt history fields 302 and a general purchase agreement region 318. Region 302 includes a transaction type field 304, a receipt number field 306, a date field 308, a quantity field 310, a destination field 312, a unit of measurement field 314, and an item number field 316. As shown, the receipt history fields 302 display the history of the receipt numbers listed within receipt number field 306. Accordingly, the user can efficiently and quickly inspect the changes that have occurred with respect to a particular receipt in a single instance. General purchase agreement region 318 includes various fields such as an order type field 320, a source field 322, an item description field 324, a destination field 326, and a receiver note field 328. An order field 330 is also illustrated as well as a transaction date field 332, a hazard field 333, and a routing field 334.

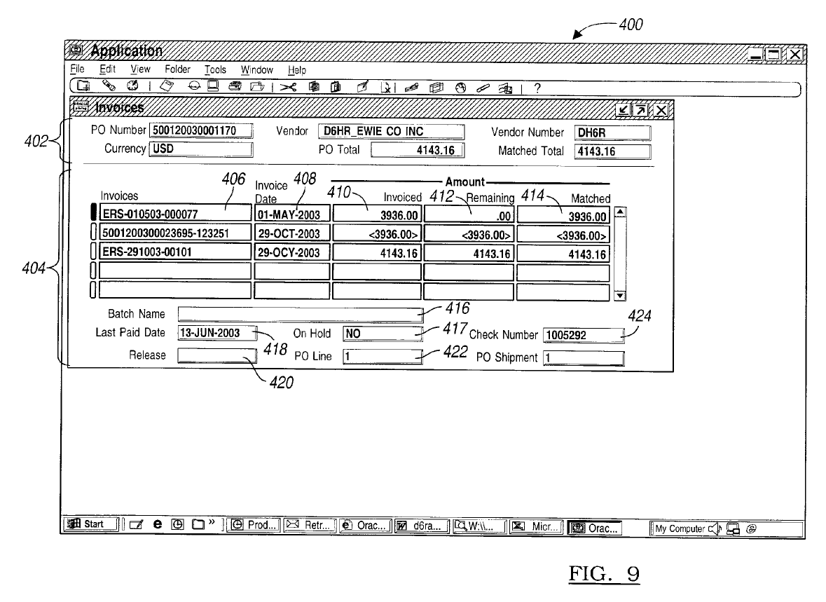

Now referring to FIG. 9, an example invoice is shown in accordance with an embodiment of the present invention. As described above, the retroactive pricing tool can create invoices for each receipt that was impacted by the retroactive price change. The invoice can be for a positive or negative amount, depending on whether the change is in favor of the buyer or the supplier. Accordingly, the retroactive pricing tool is configured to generate a debit or credit memorandum as a result of the retroactive pricing event. Form 400 includes a general invoice data region 402 and an invoice table 404. Data region 402 may include information such as the purchase order number, the agreed upon currency, vendor information, vendor number, a purchase order total, and a match total.

Invoice table 404 includes various fields for displaying the invoices affected by the retroactive purchasing event. Accordingly, an invoice field 406 displays the particular invoice number affected by the retroactive pricing event. An invoice date field 408 displays the date of the invoice and an invoice amount field 410 displays whether a debit or credit has been calculated. A remaining amount field 412 displays any remaining amounts to be debited or credited. Invoice table 404 also includes a matched amount field 414. Form 400 also includes a batch name field 416, a hold field 417, a last paid date field 418, and a release field 420. Form 400 may include a purchase order line field 422, a check number field 424, and a purchase order shipment field 426.

While the best mode for carrying out the invention has been described in detail, those familiar with the art to which this invention relates will recognize various alternative designs and embodiments for practicing the invention as defined by the following claims.

What is claimed is:

1. An electronic method for executing retroactive price adjustments involving a computer, wherein the computer is configured to receive a purchase agreement pertaining to goods and/or services, the method comprising:
receiving a price adjustment on a pricing line of the purchase agreement through the use of the computer;
receiving an effective start date in which the price adjustment will take effect;
identifying release orders associated with the purchase agreement that are affected by the retroactive price adjustment via the computer; and
updating the release orders and the purchase agreement to reflect the price adjustment.

2. A method according to claim 1, further comprising receiving multiple price adjustments and effective start dates for each price adjustment.

3. A method according to claim 1, further comprising:
issuing a receipt that reflects the price adjustment; and
entering a price adjustment for a first percentage of the goods and/or services and additional price adjustments for the remaining percentage of the goods and/or services.

4. A method according to claim 1, further comprising issuing a receipt history.

5. A method according to claim 1, further comprising generating an invoice.

6. A method according to claim 1, further comprising capturing a price change history on the purchase agreement.

7. A method according to claim 6, wherein capturing price change history on the purchase agreement includes capturing a revision number.

8. A method according to claim 1, further comprising generating a purchase agreement change notification.

9. A method according to claim 1, further comprising:
determining whether a debit or credit is required; and
generating a debit or credit memorandum.

10. A method according to claim 1, further comprising receiving a price adjustment approval through the use of the computer prior to updating the release orders and the purchase agreement to reflect the price adjustment.

11. A computer-implemented system for executing retroactive price adjustments including a computer, the computer being configured to:
receive a price adjustment on a pricing line of a purchase agreement;
receive an effective start date in which the price adjustment will take effect;
identify release orders affected by the retroactive price adjustment; and
update the release orders and the purchase agreement to reflect the price adjustment.

12. A system according to claim 11, wherein the computer is further configured to receive multiple price adjustments and effective start dates for each price adjustment.

13. A system according to claim 11, wherein the computer is further configured to issue a receipt that reflects the price adjustment.

14. A system according to claim 11, wherein the computer is further configured to issue a receipt history.

15. A system according to claim 11, wherein the computer is further configured to generate an invoice.

16. A system according to claim 11, wherein the computer is further configured to capture price change history on the purchase agreement.

17. A system according to claim 16, wherein the computer being configured to capture price change history on the purchase agreement is further configured to capture a revision number on the purchase agreement.

18. A computer-implemented method for executing retroactive price adjustment for a product or service, wherein the product or service has been at least partially received by a buyer and the computer is configured to receive a purchase agreement that is associated with the product or service, the method comprising:
receiving a price adjustment on a pricing line of the purchase agreement;
receiving an effective start date in which the price adjustment will take effect;
identifying release orders, receipts, and invoices associated with the purchase agreement that are affected by the retroactive price adjustment; and
updating the receipts and the invoices for goods or services received; and
updating the release orders and the purchase agreement to reflect the price adjustment for goods or services received and for goods or services not yet received.

19. A method according to claim 18, further comprising:
receiving multiple price adjustments and effect start dates for each price adjustment.

20. A method according to claim 18, further comprising capturing a price change history and the purchase agreement.
